(19) United States
(12) Patent Application Publication
(10) Pub. No.: US 2016/0063595 A1
(43) Pub. Date: Mar. 3, 2016

(54) Automatically Pre-Customizing Product Recommendations for Purchase

(71) Applicant: Staples, Inc., Framingham, MA (US)

(72) Inventors: Burc Oral, Lexington, MA (US); Pratabkumar Vemana, Westborough, MA (US); Michael William Bailey, Hopkinton, MA (US); Behzad Soltani, Boston, MA (US)

(73) Assignee: Staples, Inc., Framingham, MA (US)

(21) Appl. No.: 14/163,537

(22) Filed: Jan. 24, 2014

(51) Int. Cl. G06Q 30/06

(52) U.S. Cl. CPC G06Q 30/0631; G06Q 30/0621

(57) ABSTRACT

An example system includes a configuration engine and a product builder. The configuration engine is executable to retrieve a template based on a product selection selecting a product and to provide the template to a user for display via a configurator. The configuration engine is further executable by the one or more computing devices to receive customization data including one or more of configuration data for configuring a template associated with the product and asset data describing one or more digital assets for the template. The product builder is executable to build a user-customized version of the product using the template and the customization data and to automatically pre-build one or more customized product recommendations in association with the user-customized version of the product based on the customization data and one or more templates associated with one or more customizable product recommendations.

### BACKGROUND

The specification relates to automatically pre-customizing product recommendations for purchase.

Shopping online for customized goods can be a laborious and time-consuming process. For instance, to customize business cards for his or her business, a user may be required to input his or her personal information to include on the card, arrange that information on the card, upload a graphic for the card, etc., during a configuration session. If that user is then interested in customizing other products, such as letter-head, banners, etc., existing solutions require the user to separately, manually configure those goods in subsequent configuration sessions, which can in some cases take several minutes or more each. This can lead to customer fatigue and eventually dissuade customers from making additional purchases that require substantial manual input and configuration. While some solutions exist that recommend additional products to users while those users are browsing and/or purchasing various items, the products being recommended are not pre-configured to the users. As a result, the users are still required to spend significant time to manually configure the products being recommended, and thus are less likely to configure and purchase them.

### SUMMARY

The subject matter described in this disclosure in general relates to automatically pre-customizing product recommendations for purchase. According to one innovative aspect of the subject matter in this disclosure, a system includes one or more computing devices, a configuration engine, and a product builder. The configuration engine is executable by the one or more computing devices to retrieve a template based on a product selection selecting a product and to provide the template to a user for display via a configurator. The configuration engine is further executable by the one or more computing devices to receive customization data including one or more of configuration data for configuring a template associated with the product and asset data describing one or more digital assets for the template. The product builder is executable by the one or more computing devices to build a user-customized version of the product using the template and the customization data and to automatically pre-build one or more customized product recommendations in association with the user-customized version of the product based on the customization data and one or more templates associated with one or more customizable product recommendations. The product builder is coupled to the configuration engine to receive the template, the one or more templates, and the customization data.

These and other implementations may each optionally include one or more of the following features: that the configuration engine includes a configuration server executable by the one or more computing devices to receive the customization data from a client device of the user, and to provide the user-customized version of the product and the one or more customized product recommendations automatically pre-built by the product builder for display to the user; a recommender executable by the one or more computing devices to determine one or more customized product recommendations; that to determine the one or more customized product recommendations includes populating the one or more templates associated with the one or more customizable product recommendations; that the recommender is coupled to the product builder to receive the customization data; that to determine the one or more templates associated with the one or more customizable product recommendations includes selecting the one or more templates based on an affinity of each of the one or more templates to the product; that to select the one or more templates based on the affinity of each of the one or more templates to the product includes determining one or more product recommendation selection criteria based on one or more of a product data, user data, business data, social network data, customer loyalty data, and popularity data; and, selecting from a template repository the one or more templates based on the one or more templates matching the one or more product recommendation selection criteria; that the recommender is further executable by the one or more computing devices to generate template configuration data from the configuration data; that the template configuration data is usable by the recommender to populate each of the one or more templates associated with the one or more customizable product recommendations; that the recommender is further executable by the one or more computing devices to use a canonical model or mapping data to populate the one or more templates associated with the one or more customizable product recommendations; that to use the canonical model to populate the one or more templates associated with the one or more customizable product recommendations includes querying a data store for a canonical representation for each of the one or more templates, normalizing one or more of the configuration data and the asset data, and populating each template of the one or more templates using a corresponding canonical representation of the template and one or more of the normalized configuration data and the normalized asset data; that to use the mapping data to populate the one or more templates associated with the one or more customizable product recommendations includes querying a data store for mapping data mapping the template associated with the product with the one or more templates associated with the one or more customizable product recommendations, determining one or more fields in each of the one or more templates that are related to one or more fields in the template as related fields based on the mapping data, and populating the related fields in the one or more templates using the customization data.

In general, another innovative aspect of the subject matter described in this disclosure may be embodied in methods that include receiving, using one or more computing devices, customization data for customizing a product, the customization data including one or more of configuration data for configuring a template associated with the product and asset data describing one or more digital assets for the template; building, using the one or more computing devices, a user-customized version of the product using the template and the customization data; in association with building the user-customized version of the product, determining, using the one or more computing devices, one or more templates associated with one or more customizable product recommendations; automatically pre-building, using the one or more computing devices, one or more customized product recommendations based on the one or more templates and the customization data; and providing, using the one or more computing devices, the user-customized version of the product and the one or more customized product recommendations that were automatically pre-built for display to the user.

These and other implementations may each optionally include one or more of the following operations: that determining the one or more templates associated with the one or more customizable product recommendations includes selecting the one or more templates based on an affinity of each of the one or more templates to the product; generating, from the configuration data using the one or more computing devices, template configuration data for configuring each of the one or more templates associated with the one or more customizable product recommendations; that automatically pre-building the one or more customized product recommendations includes configuring each of the one or more templates using the asset data and the template configuration data; that selecting the one or more templates based on the affinity of each of the one or more templates to the product includes determining one or more product recommendation selection criteria based on one or more of a product data, user data, business data, social network data, customer loyalty data, and popularity data, and selecting, from a template repository the one or more templates based on the one or more templates matching the one or more product recommendation selection criteria; that automatically pre-building the one or more customized product recommendations based on the one or more templates and the customization data includes using a canonical model or mapping data to populate the one or more templates associated with the one or more customizable product recommendations; that using the canonical model to populate the one or more templates associated with the one or more customizable product recommendations includes querying a data store for a canonical representation for each of the one or more templates associated with the one or more customizable product recommendations, normalizing one or more of the configuration data and the asset data, and populating each template of the one or more templates associated with the one or more customizable product recommendations using a corresponding canonical representation of the template and one or more of the normalized configuration data and the normalized asset data; that using the mapping data to populate the one or more templates associated with the one or more customizable product recommendations includes querying a data store for mapping data mapping the template associated with the user-customized version of the product with the one or more templates associated with the one or more customizable product recommendations, determining one or more fields in each of the one or more templates that are related to one or more fields in the template as related fields based on the mapping data, and populating the related fields in the one or more templates using the customization data; receiving, using the one or more computing devices, a product selection from the user, the product selection selecting the product; retrieving, using the one or more computing devices, the template based on the product selection; providing, using the one or more computing devices, the template to the user for display via a configurator; receiving, using the one or more computing devices, a purchase request to purchase the user-customized version of the product and at least one of the one or more customized product recommendations; transacting, using the one or more computing devices, a sale of the user-customized version of the product and the at least one of the one or more customized product recommendations; and facilitating, using the one or more computing devices, ordering and fulfillment of the user-customized version of the product and the at least one of the one or more customized product recommendations.

In general, another innovative aspect of the subject matter described in this disclosure may be embodied in methods that include determining, using one or more computing devices, a canonical model for normalizing data describing a set of templates associated with a catalog of configurable products; normalizing, using the one or more computing devices, the data associated with each of the templates of the set using the canonical model to produce a canonical representation of each of the templates; and storing, using the one or more computing devices, a set of normalized data for each of the templates of the set in a data store.

These and other implementations may each optionally include one or more of the following operations: receiving, using the one or more computing devices, a request to automatically pre-build one or more customized product recommendations in association with a user-customized version of a product; determining, using the one or more computing devices, one or more templates associated with one or more customizable product recommendations; querying, using the one or more computing devices, a data store for the canonical representation of each of the one or more templates; normalizing, using the one or more computing devices, one or more of configuration data and asset data associated with the user-customized version of the product; populating, using the one or more computing devices, the canonical representation of each of the one or more templates using one or more of the normalized configuration data and the normalized asset data; and generating, using the one or more computing devices, one or more customized product recommendations respectively from a populated version of the canonical representation of each of the one or more templates; receiving, using the one or more computing devices, template data from one or more third-party sources via a computer network, the template data describing one or more templates associated with one or more configurable products producible by the one or more third-party sources; including, using the one or more computing devices, the one or more configurable products producible by the one or more third-party sources in the catalog; and storing, using the one or more computing devices, the one or more templates in a template repository in association with the set of templates.

In general, another innovative aspect of the subject matter described in this disclosure may be embodied in methods that include determining, using one or more computing devices, mapping data for a set of templates associated with a catalog of configurable products, the mapping data describing fields of the templates that are related; and storing, using the one or more computing devices, the mapping data in a data store.

These and other implementations may each optionally include one or more of the following operations: receiving, using the one or more computing devices, a request to automatically pre-build one or more customized product recommendations in association with a user-customized version of a product; determining, using the one or more computing devices, one or more templates associated with one or more customizable product recommendations; querying, using the one or more computing devices, the data store for a set of mapping data mapping a first template associated with the product with one or more second templates associated with the one or more customizable product recommendations; determining, using the one or more computing devices, one or more fields in the one or more second templates that are related to one or more fields in the first template based on the mapping data; populating, using the one or more computing devices, the one or more fields in the one or more second templates that are related to the one or more fields in the first template using customization data associated with the user-customized version of the product; receiving, using the one or more computing devices, template data from one or more third-party sources via a computer network, the template data describing one or more templates associated with one or more configurable products producible by the one or more third-party sources; including, using the one or more computing devices, the one or more configurable products producible by the one or more third-party sources in the catalog; and storing, using the one or more computing devices, the one or more templates in a template repository in association with the set of templates.

In general, another innovative aspect of the subject matter described in this disclosure may be embodied in methods that include receiving a product selection selecting a product from a user via a computing device; retrieving via the computing device a template associated with the product selection; providing the template for display via a configurator interface presented by the computing device; receiving one or more of configuration data and asset data from the user via the configurator interface; customizing a user-customizable product associated with the template by applying one or more of the configuration data and the asset data to the template; automatically retrieving from a computer network one or more pre-customized product recommendations associated with the user-customizable product; and providing in association with the user-customizable product the one or more pre-customized product recommendations to the user via the computing device for purchase or further configuration.

These and other implementations may each optionally include one or more of the following operations: that applying the one or more of the configuration data and the asset data to the template includes sending a request to a configuration engine accessible via the computer network, the request requesting the configuration engine to customize the user-customizable product using the one or more of the configuration data and the asset data, receiving data describing a customized version of the user-customizable product, and updating the configurator interface to present the customized version of the user-customizable product based on the data.

Other implementations of one or more of these aspects include corresponding systems, apparatus, and computer programs, configured to perform the actions of the methods, encoded on computer storage devices. The language used in this disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIGS. 1 and 2 are block diagrams illustrating example systems for customizing products and automatically generating pre-customized product recommendations for purchase.

FIG. 3 is a block diagram illustrating an example computing system.

FIG. 4 is a flowchart of an example method for providing user-customized products and automatically pre-customized product recommendations.

FIG. 5A is a flowchart of an example method for determining templates and pre-building customized product recommendations.

FIG. 5B is a flowchart of an example method for selecting product templates from a template repository.

FIG. 6 is a flowchart of an example method for normalizing templates using a canonical model.

FIG. 7 is a flowchart of an example method for populating templates using a canonical model.

FIG. 8 is a flowchart of an example method for generating and storing mapping data.

FIG. 9 is a flowchart of an example method for populating templates using mapping data.

FIG. 10 is a flowchart of an example method for customizing a product and automatically receiving pre-customized product recommendations.

FIG. 11 is a flowchart of an example method for browsing a product catalog and selecting a product.

FIG. 12 is a flowchart of an example method for sale transaction and order fulfillment.

FIG. 13 is a graphic representation of example configurator interface for customizing a product and receiving pre-customized product recommendations.

### DETAILED DESCRIPTION

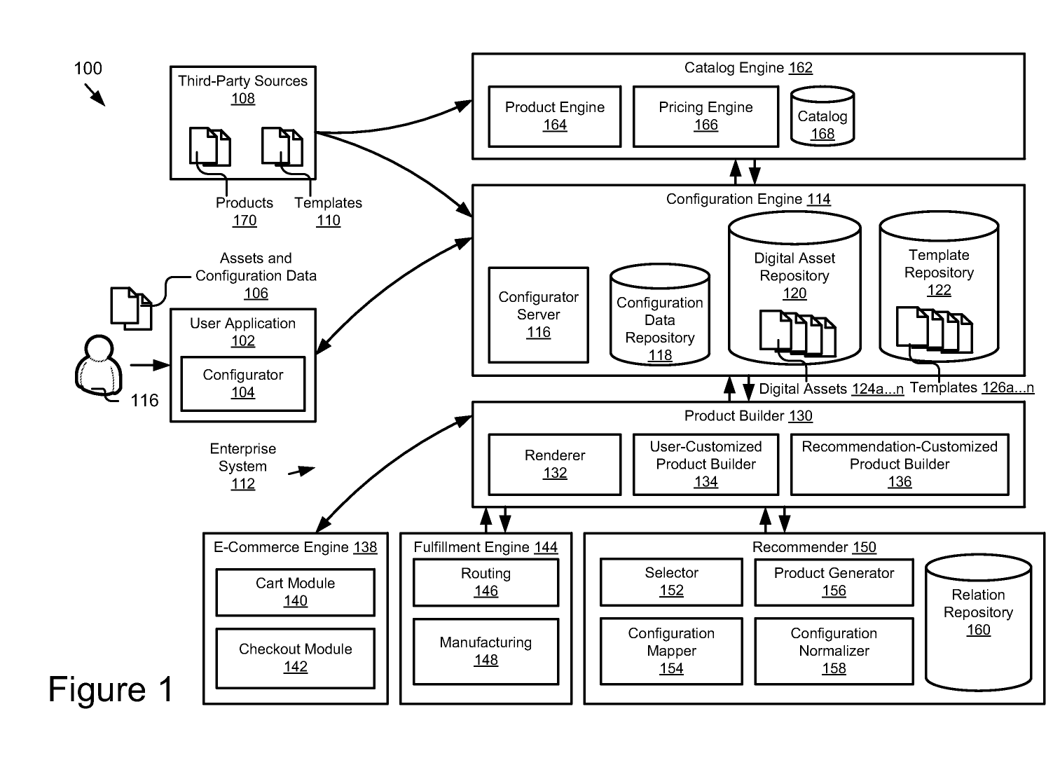

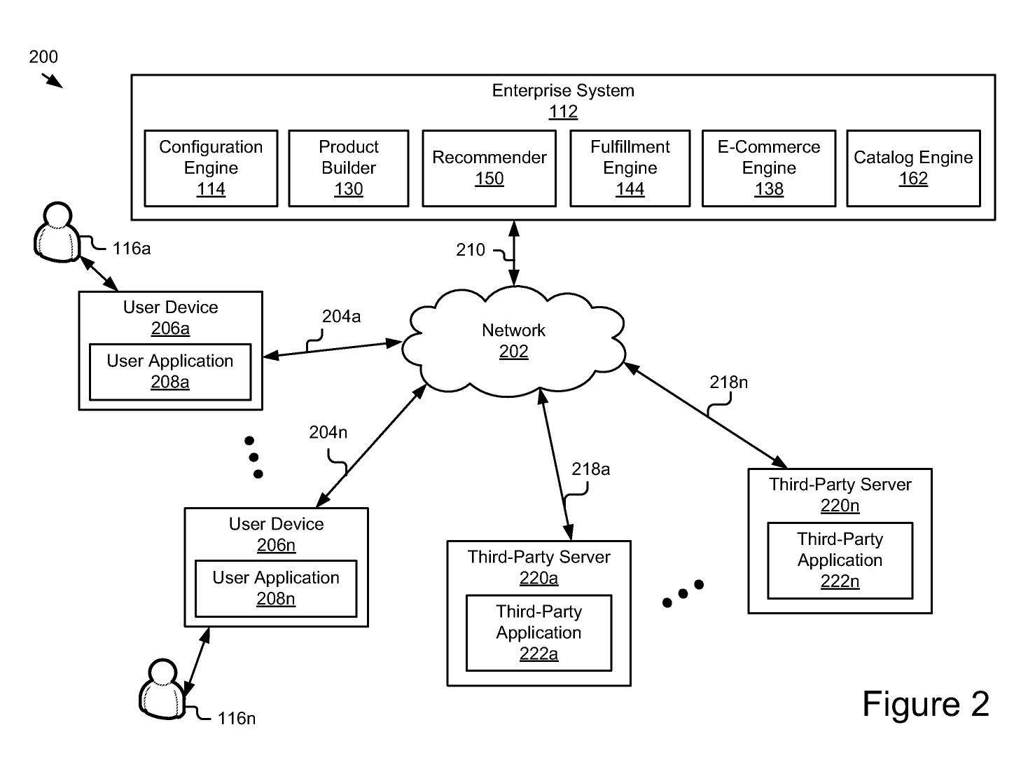

FIGS. 1 and 2 are block diagrams of example systems 100 and 200 for customizing products and automatically generating pre-customized product recommendations for purchase. As depicted, the system 100 includes a user application 102 accessible by a user 116, third-party sources 108, and an enterprise system 112. The user application 102 may include a configurator 104 for configuring customizable products. The user 116 may use the user application 102 and configurator 104 to input asset and configuration data 106 to configure the customizable product. Customizable products may include any product or service that is suitable for customization. For instance, in various embodiments described herein, copy and print products may be customized using the configurator 104, although it should be understood that the configurator 104 is not limited to the configuration of such products and that numerous other types of products or services may be configured using the configurator 104, the user application 102, and the enterprise system 112.

Asset data includes digital assets such as photographs, graphics, icons, or any other multimedia. The asset data may be provided in any conventional file format including, but not limited to, JPG, GIF, PNG, SVG, etc. The asset data may be uploaded from a file system of a client device of the user 116 or provided from any other information source, such as a remote storage device or server coupled to a computer network. For instance, the asset data may include an electronic link (e.g., a hyperlink) to a digital image accessible via the computer network (e.g., the Internet).

Configuration data includes any data provided for configuring one or more products. In some embodiments, the configuration data may include contact information, business information, personal information, social information, event-related information, date and time information, marketing information, product design information such as but not limited to data specifying various colors, sizes, shapes, finishes (e.g., holes, folding, etc.), or any other information that can be used to customize and/or personalize a product. In some examples, the configuration data may include an address, name, and title of the user. In some examples, the configuration data may describe a party being planned by the user and may include the name, date, time, and location of the party. In some embodiments, the user may input the configuration data directly, or may direct the enterprise system 112 to access the configuration data from another information source, such as a social network or other computer network computing resource.

As depicted in FIG. 1, the enterprise system 112 may include a catalog engine 162, a configuration engine 114, a product builder 130, a recommender 150, a fulfillment engine 144, and an e-commerce engine 138. The catalog engine 162 provides users with the ability to browse, research, and select products for purchase. Users may access the services provided by the catalog engine 162 via the user application 102, such as a mobile application, a web-application, or another suitable software application, etc. An example of a catalog engine 162 includes the digital office supply store accessible at http://www.staples.com.

In the depicted embodiment, the catalog engine 162 includes a product engine 164, a pricing engine 166, and a catalog 168. The catalog 168 stores and provides access to product-related information, such as general and detailed information about various products (e.g., physical products, digital products, business services, consumer services, etc.) including product specifications, retail pricing information, vendor and affiliate information, etc. In some embodiments, each customizable product stored in the catalog 168 may be associated with a corresponding product template (also referred to herein as a template) that includes one or more aspects that may be configured based on customization data provided by a user. As depicted in FIG. 1, in some embodiments, templates 110 may be provided by third-party sources 108 for storage in a template repository 122, which is discussed in further detail below. This is advantageous as it allows third parties to use the enterprise system 112 as a configuration service and have their products customized by users without having to host, develop, and maintain their own end-to-end product configuration and e-commerce solution. It further can provide a marketplace for product templates including, for instance, highly specialized templates that can be selected and configured by users.

The product engine 164 is configured to manage, store, and retrieve information about products, such as customizable products, stored in the catalog 168. The product engine 164 may receive and respond to various queries for product-related information, facilitate the browsing and detailed look-up of products stored in the catalog 168, etc. In some embodiments, the product engine 164 may add, update, and remove products to/in/from the catalog 168. For instance, the product engine 164 may include software (e.g., a web application) configured to allow third-party sources 108, such as affiliates, vendors, employees, etc., to add new customizable products, update existing customizable products, and remove various customizable products (collectively products 170) to/in/from the catalog 168, as well as make corresponding additions, revisions, deletions, etc., in the template repository 122. In some embodiments, a third party source 108 may upload a customizable product 170 and a corresponding product template 110 to the enterprise system 112, and the enterprise system 112 may store the product 170 and template 110 in the catalog 168 and the template repository 122, respectively. For instance, the product engine 164 may receive the product 170 and the template 110 in a request from a third-party source 108 (e.g., a client device of an affiliate) and the product engine 164 may store the product 170 in the catalog 168 and provide the template 110 to the configuration engine 114 for storage in the template repository 122. In turn, the configuration engine 114 may store the template in the template repository 122. In further examples, the template 110 may be submitted to the configuration engine 114 directly by the third-party source 108 for storage in the template repository 122. For instance, a configurator server 116 may receive a template submission request from a third-party source 108, which may include information identifying which product the template is associated with, and the configurator server 116 may store the template in the template repository 122 in association with that product. Other alternatives are also possible.

The pricing engine 166 is configured to compute, manage, store, and retrieve pricing information for the products stored in the catalog 168. In some embodiments, the pricing engine 166 may store pricing information, such as retail prices, sale prices, historical prices, etc., in a data store in association with the products, such as the catalog 168 or another data store (e.g., a database).

The configuration engine 114 facilitates user-customization and automatic customization and recommendation of products. As depicted, the configuration engine 114 includes a configurator server 116, a configuration data repository 118, a digital asset repository 120, and a template repository 122. The configurator server 116 receives and responds to various configuration requests received from one or more instances of the configurator 104, such as configuration requests, save requests, retrieval requests, etc. The configuration data repository 118 stores the configuration data provided by users and the digital asset repository 120 stores asset data describing digital assets 124a . . . n (also referred to herein as individually and/or collectively as 124) provided by users. The template repository 122 stores templates 126a . . . n (also referred to herein as individually and/or collectively as 126) for the customizable products included in the catalog 168.

In some embodiments, a configuration request may include customization data for customizing a product. The customization data may include configuration data describing how to configure the product and/or asset data describing digital assets to incorporate into the product. In some embodiments, the configuration data may include text to include in the product and formatting data describing how the text and/or digital assets should be formatted. For instance, the configuration data may include formatting parameters indicating what typefaces, font sizes, textual treatments (e.g., underlining, italicizing, bolding, etc.), highlighting, shadowing, etc., should be used for the various textual passages also included in the configuration data. In a further example, the configuration data may describe how to format digital assets included in the asset data, such has how to resize and position various graphics, photographs, or other multimedia included in the asset data.

In some embodiments, a user may submit a request via the configurator 104 to retrieve a previously customized product that the user saved at an earlier time for further customization or purchase, and the configurator server 116 may retrieve the customized template from the template repository 122 and provide it to the instance of the configurator 104 being used by the user for review, purchase, and/or further configuration. In some further embodiments, the configurator server 116 may signal the product builder 130 to rebuild the customized product real-time using the corresponding template and customization data stored in association with a user account for the user and retrievable from the configuration data repository 118 and the digital asset repository 120, and the product builder 130 may build the user-customized product using the corresponding template and customization data and then provide it to the applicable configurator 104 for review, purchase, and/or further configuration by the user. Other variations are also possible, such as where the product builder 130 relays the customized products built by it to the configuration engine 114 for provision to the user.

In some embodiments, a user may want to customize a customizable product selected from the catalog 168 for the first time and the configurator server 116 may receive a configuration request that includes a product identifier for the customizable product and may retrieve the corresponding product template from the template repository 122 and provide the product template to the instance of the configurator 104 being used by the user for display and configuration by the user.

The configurator server 116 may store the customization data it receives from users for customizing customizable products in the configuration data repository 118 and digital assets repository 120 as appropriate in association with the customizable product and/or the user, and/or may provide the customization data it receives to the product builder 130 for use thereby in building the user-customized product as well as automatically pre-building customized product recommendations, as discussed in further detail herein. The other entities of the enterprise system 112 may access the information stored in the repositories 118, 120, and 122 of the configuration engine 114 either by directly interacting with the repositories or via intermediate software such as an API of the configuration engine 114.

The product builder 130 is configured to receive configuration-related information for a product, such as templates, customization data (e.g., configuration data, asset data, etc.), etc., and to create customized products including user-customized products configured via the configurator 104 instances and automatically pre-customized products to recommend to the user (referred to herein as product recommendations). In particular, the product builder 130 includes a renderer 132, a user-customized product builder 134, and a recommendation-customized product builder 136.

The user-customized product builder 134 is configured to build the specific products customized by users using the configurator 104 instances. In some embodiments, to build/generate a user-customized product, the user-customized product builder 134 receives customization data including one or more of configuration data and asset data from the applicable configurator 104, receives the template associated with the configurable product from the configuration engine 114, populates the template with the customization data in the manner instructed by the user, and generates the user-customized product from the populated template. In some instances, when generating the user-customized product, the data forming the user-customized product may be optimized, flattened, and/or compressed, etc., and then rendered to the user (via the renderer 132) for final inspection and/or stored in a non-transitory storage medium in association with the user for later access (e.g., when the fulfillment engine 144 manufacturing an actual physical representation of the product).

The recommendation-customized product builder 136 is configured to automatically pre-build customized product recommendations for provision to a user. In some embodiments, the recommendation-customized product builder 136 is called by the product builder 130 to pre-customize product recommendations responsive to the product builder 130 being called by the configuration engine 114 to build the user-customized product, although other embodiments are also possible, such as where the configuration engine 114 acts as a controller and signals the user-customized product builder 134 and the recommendation-customized product builder 136 to build their respective customized products. Automatically pre-building customized product recommendations is advantageous because these recommendations can automatically be provided to the user along with the specific product or products being configured by the user, which provides the user with a wider selection of customized products without requiring any additional time from the user to configure the additional products, and can ultimately lead to an increase in the amount and number of customized products that are ultimately purchased by the user.

In some embodiments, the recommendation-customized product builder 136 signals the recommender 150 to find products to recommend and generate product recommendations using at least in part the customization data provided by the user for the product he/she is configuring/has configured using the configurator 104. The product recommendations may be based on one or more templates that are related to a current template that the user is working with.

As depicted in FIG. 1, the recommender 150 includes a selector 152, a configuration mapper 154, a configuration normalizer 158, a product generator 156, and a relation repository 160. The selector 150 is configured to find a set of product/product templates that have an affinity to the base product(s)/template(s) being configured by the user.

The selector 152 may leverage the relation repository 160 to determine an affinity between two or more templates. The selector 152 may query the relation repository 152 using one or more rules and the relation repository 160 may return a result including one or more template IDs associated with the one or more templates matching the rules. In some embodiments, the selector 152 may include a simplified rules engine configured to evaluate the affinities/relations between the templates and find matching template(s).

Affinities/relations between the templates may be defined in the relation repository 160 as a graph, taxonomy, ontology, or crowd-sourced attribute set and the selector 152 may query the relation repository 160 to determine how closely related a given template is to other templates. In some embodiments, affinities/relations between templates may be based on template attributes. For instance, the relation repository 160 may include abstracted relations from the template attributes so that a simpler structure-based (e.g., graph, ontological, etc.) matching can be done. This is advantageous as it can reduce the complexity of the selector 152 logic and/or rules and increase query response time. However, it should be understood that other alternatives for the selector 152 are possible, including a selector that includes more complex logic for selecting templates from the template repository 122 based on template attributes.

In some instances, strength of the affinity between a given template and other templates may be quantified by the relation repository 160 and the selector 152 may query the relation repository 160 for templates that meet a certain affinity threshold to limit the results set to the most relevant products. In some embodiments, the selector 152 may select one or more templates from the template repository 122 based on one or more product recommendation selection criteria that satisfy a given affinity/relation between the template being customized by the user and the templates of other products.

The strength of an affinity between templates may be based on various data including one or more of a product data, user data, business data, social network data, customer loyalty data, and popularity data. For instance, the affinities may be based on one or more of a feature of the base product (e.g., a product category, a product type, a product price, etc.), a feature of the template that corresponds to the base product (e.g., a corresponding field), a user attribute (e.g., age, gender, user preference, etc.), a business attribute (e.g., user's profession, industry vertical, title, etc.), an event-related attribute (e.g., party, concert, meeting, etc.), a temporal attribute (e.g., time of year/season), a customer loyalty attribute (e.g., user's purchase history), a social network attribute (e.g., products liked, commented, or posted in a social network), popularity of a product relative to other products, etc. In some cases, the more ways two given templates have attributers in common, the stronger (e.g., higher) the affinity between the templates. Other factors may also be considered in and/or strengthen the affinity value, such as the overall popularity of the product or other attributes discussed herein. In some embodiments, using affinity to find templates of products to recommend is advantageous as it increases the probability that the templates may be customized based on the customization data being used by the user-customized product builder 134.

In some embodiments, when a template is added to the template repository 122, or an existing template in the template repository 122 is modified, the recommender 150 may update the relationship between that template and other templates in the relation repository 160 based on the changes. In some embodiments, when template is modified, a new template may be created from the original template that includes the modifications. This allows the original template to be preserved for continued use if necessary. In some embodiments, a template that is no longer needed may be flagged as inactive in the template repository 122.

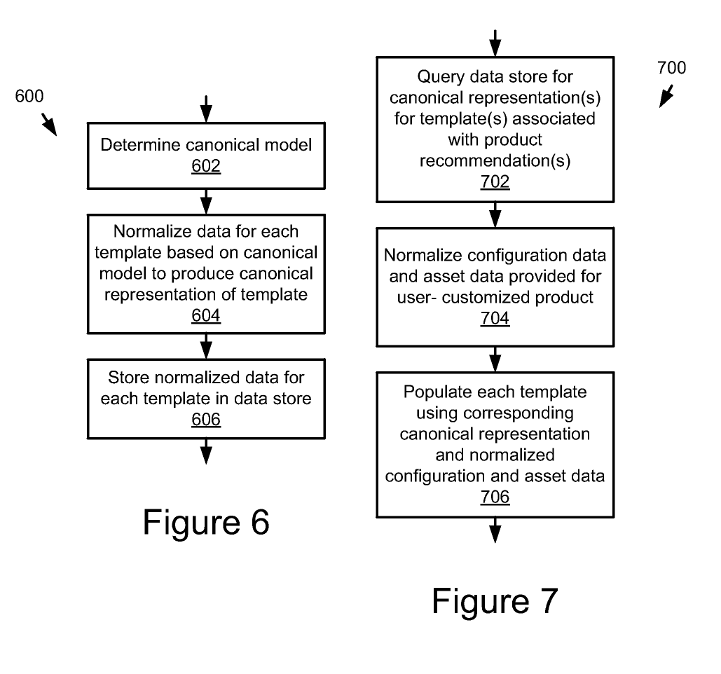

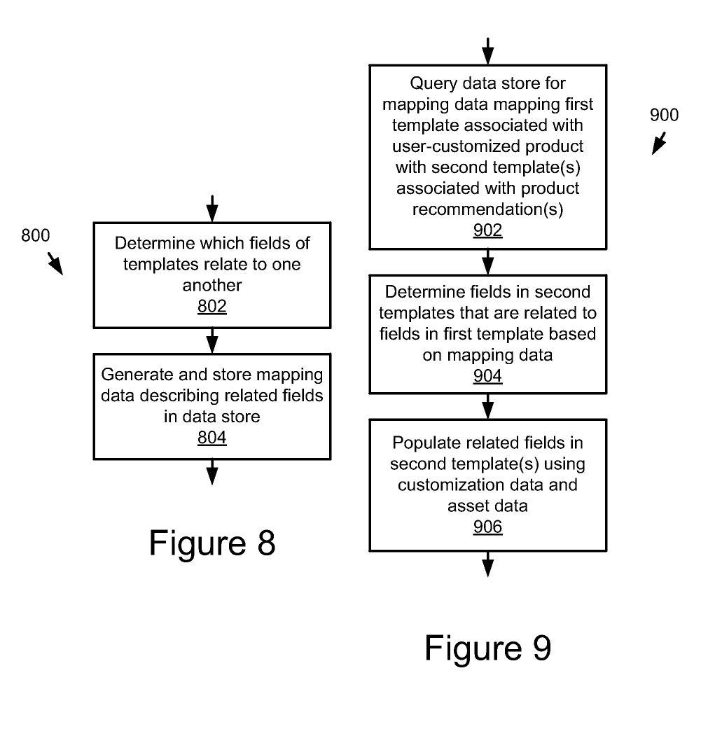

Once a set of templates has been selected by the selector 152, the recommender 150 may populate the templates using the customization data. In some embodiments, the recommender 150 may populate the templates using a canonical model or mapping data to populate the one or more templates associated with the one or more customizable product recommendations. For instance, the recommender 150 may include a configuration normalizer 158 adapted to populate the templates using the canonical model, as discussed in further detail below with reference to at least FIGS. 6 and 7. Additionally or alternatively may include a configuration mapper 154 that populates the set of templates using the mapping data, as discussed in further detail below with reference to at least FIGS. 8 and 9.

The product generator 156 is configured to generate the pre-customized products based on the populated templates. Depending on the approach used to populate the set of templates, the product generator 156 may be coupled to the configuration normalizer 158 or the configuration mapper 154 to receive a populated set of templates and may generate one or more pre-customized product recommendations based on the populated set of templates. For instance, the product generator 156 may generate the pre-customized product recommendations by optimizing, compressing, flattening, etc., the data describing each of the populated templates and then storing and/or providing data describing each of the customized product recommendations to the recommendation-customized product builder 136 for provision to the user in conjunction with the user-customized product built by the user-customized product builder 134.

The renderer 132 is configured to render a final version of the user-customized product(s) and/or the pre-built customized product recommendations and provides the final version of those product(s) for verification. Once the user is satisfied with the configuration, the user can add the user-customized product(s) to a virtual shopping cart in conjunction with any automatically pre-customized products the user wishes to purchase and the user checks out using the e-commerce engine 138. Once payment has been verified, the fulfillment engine 144 can facilitate the manufacturing and shipping of the customized products to the user or another person or entity designated by the user during the check-out process. As depicted in FIG. 1, the e-commerce engine 138 includes a cart module 140 configured to track the items added by the user to his/her virtual shopping cart and a checkout module 142 configured to facilitate the purchase of the items in the shopping cart. The fulfillment engine 144 includes a routing block 146, which represents a logistics system for routing and shipping the customized products to the user and a manufacturing block 148, which represents a fabricator configured to manufacture and package the customized goods for delivery to the user.

The data stored and maintained by the catalog 168, the template repository 122, the digital asset repository 120, the configuration data repository 118, and the relation repository 160 may be organized and queried using various criteria including any type of data stored by them, such as a product identifier, template identifier, relation data, other unique keys, etc. The repositories 168, 118, 120, 122, and/or 160 may include data tables, databases, or other organized collections of data. The repositories 168, 118, 120, 122, and/or 160 may all be included in the same storage device or system, or disparate storage systems.

In some implementations, the repositories 168, 118, 120, 122, 160, and/or any other data stores in the systems 100 and 200 may include a database management system (DBMS). For example, the DBMS could include a structured query language (SQL) DBMS, a NoSQL DMBS, various combinations thereof, etc. In some instances, the DBMS may store data in multi-dimensional tables comprised of rows and columns, and manipulate, i.e., insert, query, update and/or delete, rows of data using programmatic operations. In some implementations, the repositories 168, 118, 120, 122, and/or 160 may be connected to a main data store (not shown) that is shared among and accessible to the components of the enterprise system 112. Additional structure, acts, and/or functionality of the enterprise system 112 are discussed in further detail below.

The system 200 in FIG. 2 depicts a network architecture that includes the enterprise system 112, user devices 206a . . . 206n (also referred to herein as individually and/or collective as 206) including user applications 208a . . . 208n (also referred to herein individually and/or collectively as 208), respectively, and third-party servers 220a . . . 220n (also referred to herein as individually and/or collectively as 220) hosting third-party applications 222a . . . 222n (also referred to herein as individually and/or collectively as 222). These entities are electronically communicatively coupled via a network 202 for interaction with one another, although other system configurations are also possible including other devices, systems, and networks. For example, the system 100 could include any number of user devices 206, enterprise systems 112, third-party servers 220, and other systems and devices.

The user devices 206a . . . 206n and their components may be respectively coupled to the network 202 via signal lines 204a . . . 204n, the enterprise system 112 and its components may be coupled to the network via signal line 210, and the third-party servers 220a . . . 220n and their components may be respectively coupled to the network 202 via signal lines 218a . . . 218n. The users 116a . . . 116n (also referred to herein as individually and/or collectively as 116) may interact with the user devices 206a . . . 206n to customize, browse, look-up, and purchase various customized products, etc.

The network 202 may include any number of networks and/or network types. For example, the network 202 may include, but is not limited to, one or more local area networks (LANs), wide area networks (WANs) (e.g., the Internet), virtual private networks (VPNs), mobile (cellular) networks, wireless local area networks (WLANs) (e.g., Wi-Fi™ networks), wireless wide area network (WWANs), WiMAX® networks, Bluetooth® communication networks, various combinations thereof, other known networks, etc.

The user devices 206 include one or more computing devices having data processing and communication capabilities. In some implementations, a user device 206 may include a processor (e.g., virtual, physical, etc.), a memory, a power source, a communication unit, and/or other software and/or hardware components, such as a display, graphics processor, wireless transceivers, keyboard, camera, sensors, firmware, operating systems, drivers, various physical connection interfaces (e.g., USB, HDMI, etc.). The user devices 206 may couple to and communicate with one another and the other entities of the system 200 via the network 202 using a wireless and/or wired connection.

Examples of user devices 206 may include, but are not limited to, mobile phones, tablets, laptops, desktops, netbooks, kiosks, server appliances, servers, virtual machines, TVs, set-top boxes, media streaming devices, portable media players, navigation devices, personal digital assistants, etc. While two user devices 206 are depicted in FIG. 2, the system 200 may include any number of user devices 206. In addition, the user devices 206 may be the same or different types of computing devices.

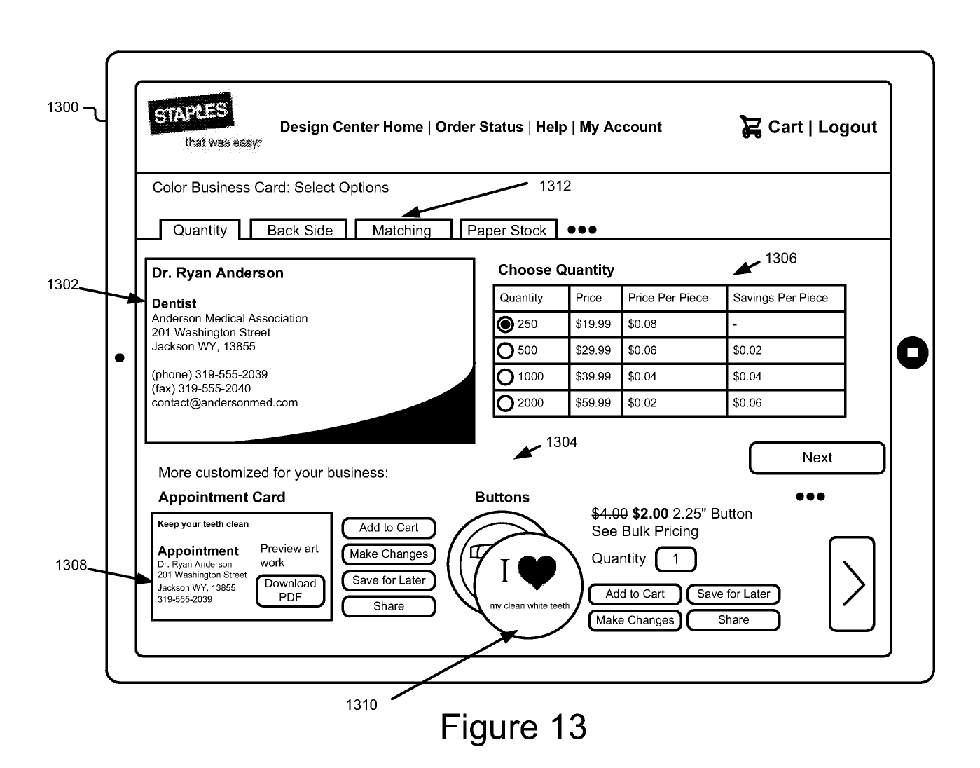

In the depicted implementation, the user devices 206 include user applications 208. A user application 208 may be storable in a memory (not shown) and executable by a processor (not shown) of a user device 206 to provide for user interaction, receive user input, present information to the user via a display (not shown), and send data to and receive data from the other entities of the system 200 via the network 202. In some implementations, the user application 208 may generate and present the user interfaces, such as the configurator interface depicted in FIG. 13 based at least in part on information received from the enterprise system 112 via the network 202. For example, a customer/user 116 may use the user application 208 to browse and configure products, receive automatically pre-build customized product recommendations, and order and track delivery of products, etc. In some implementations, the user application 208 includes a web browser and/or code operable therein, a customized client-side application (e.g., a mobile application), a combination of both, etc.

The third-party servers 220 include one or more computing devices or systems for providing various computing functionalities, services, and/or resources to the other entities of the systems 100 and 200. In some embodiments, a third-party server 220 hosts a network-based software application (e.g., a third-party application 222) operable to provide computing functionalities, services and/or resources or functionalities, and to send data to and receive data from the other entities of the systems 100 and 200. In some embodiments, the third-party server 220 is a server, server array or any other computing device, or group of computing devices, having data processing, storing and communication capabilities. Examples of the types of software services that the third-party servers 220 may provide include third-party template and product sourcing; internet searching; social networking; web-based email; blogging; micro-blogging; photo management; video, music and multimedia hosting, distribution, and sharing; business services; news and media distribution; or any combination of the foregoing services. It should be understood that the third-party servers 220 are not limited to providing the above-noted services and may include any other network-based or cloud-based service.

It should be understood that the systems 100 and 200 illustrated in FIGS. 1 and 2 are representative of an example, and that a variety of different system environments and configurations are contemplated and are within the scope of the present disclosure. For instance, various functionality may be moved between computing systems and servers, from a server to a client, or vice versa, data may be consolidated into a single data store or further segmented into additional data stores, and some implementations may include additional or fewer computing devices, services, and/or networks, and may implement various functionality client or server-side. Further, various entities of the system may be integrated into to a single computing device or system or additional computing devices or systems, etc.

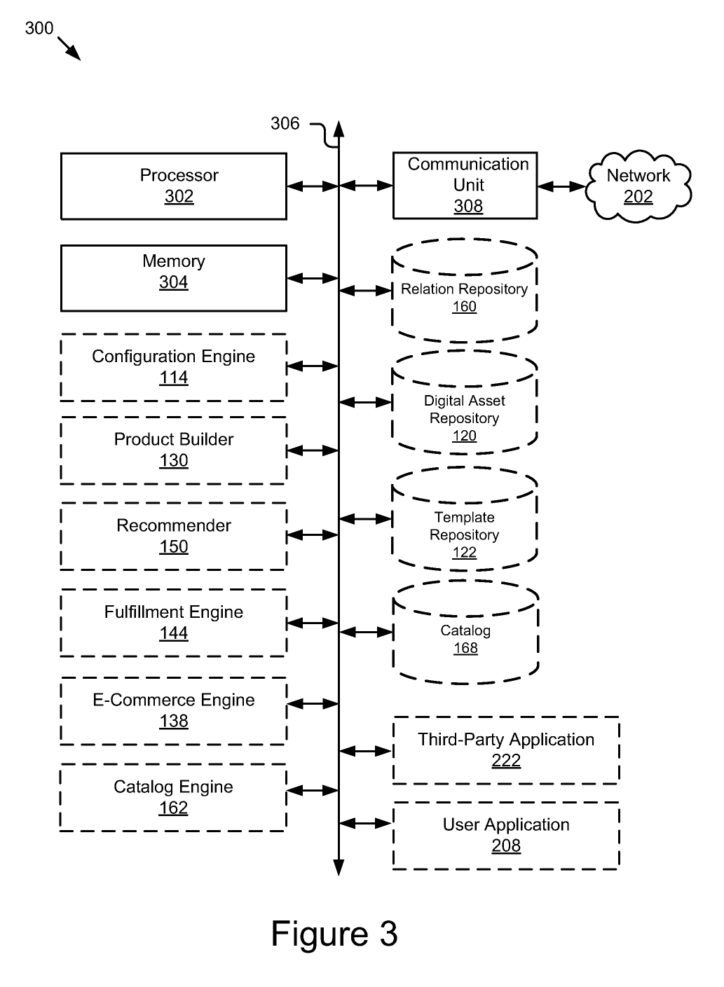

FIG. 3 is a block diagram illustrating an example computing system 300. The computing device 300 may include different components depending on the specific device or system it represents. In various embodiments, the computing system 300 may include a processor 302, a memory 304, a communication unit 308, and one or more applications and data stores, which may be communicatively coupled by a communication bus 306. For instance, the computing system 300 may represent one or more computing devices of the enterprise system 112 and may include the catalog engine 162, the configuration engine 114, the product builder 130, the recommender 150, the fulfillment engine 144, and/or the e-commerce engine 138, or various components thereof; and/or the relation repository 160, the digital asset repository 120, the template repository 122, and/or the catalog 168. In further examples, the catalog engine 162, the configuration engine 114, the product builder 130, the recommender 150, the fulfillment engine 144, and/or the e-commerce engine 138, or various components thereof, may be distributed across any number of disparate computing systems 300 that are coupled for communication and interaction via a network (e.g., a LAN, the Internet, an Intranet, VPN, etc.). In further examples, the computing system 300 may represent a third-party server 220 or a user device 206, in which the computing system 300 may respectively include the third-party application 222 or the user application 208.

The computing system 300 depicted in FIG. 3 is provided by way of example and it should be understood that it may take other forms and include additional or fewer components without departing from the scope of the present disclosure. For example, while not shown, the enterprise system 112 may include input and output devices (e.g., keyboard, display, etc.), various operating systems, sensors, additional processors, and other physical configurations.

The processor 302 may execute software instructions by performing various input/output, logical, and/or mathematical operations. The processor 302 may have various computing architectures to process data signals including, for example, a complex instruction set computer (CISC) architecture, a reduced instruction set computer (RISC) architecture, and/or an architecture implementing a combination of instruction sets. The processor 302 may be physical and/or virtual, and may include a single core or plurality of processing units and/or cores. In some implementations, the processor 302 may be capable of generating and providing electronic display signals to a display device (not shown), supporting the display of images, capturing and transmitting images, performing complex tasks including various types of feature extraction and sampling, etc. In some implementations, the processor 302 may be coupled to the memory 304 via the bus 306 to access data and instructions therefrom and store data therein. The bus 306 may couple the processor 302 to the other components of the computing system 300.

The memory 304 may store and provide access to data to the other components of the enterprise system 112. In some implementations, the memory 304 may store instructions and/or data that may be executed by the processor 302. For example, the memory 304 may store the catalog engine 162, the configuration engine 114, the product builder 130, the recommender 150, the fulfillment engine 144, and/or the e-commerce engine 138, or components thereof as appropriate. The memory 304 is also capable of storing other instructions and data, including, for example, an operating system, hardware drivers, other software applications, databases, etc. The memory 304 may be coupled to the bus 306 for communication with the processor 302 and the other components of computing system 300.

The memory 304 includes a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 302. In some implementations, the memory 304 may include one or more of volatile memory and non-volatile memory. For example, the memory 304 may include, but is not limited, to one or more of a dynamic random access memory (DRAM) device, a static random access memory (SRAM) device, a discrete memory device (e.g., a PROM, FPROM, ROM), a hard disk drive, an optical disk drive (CD, DVD, Blue-ray™, etc.). It should be understood that the memory 304 may be a single device or may include multiple types of devices and configurations.

The bus 306 can include a communication bus for transferring data between components of a computing device or between computing devices, a network bus system including the network 202 or portions thereof, a processor mesh, a combination thereof, etc. In some implementations, various components of the computing system 300 may cooperate and communicate via a software communication mechanism included in or implemented in association with the bus 306. The software communication mechanism can include and/or facilitate, for example, inter-process communication, local function or procedure calls, remote procedure calls, etc.

The communication unit 308 may include one or more interface devices (I/F) for wired and wireless connectivity with the network 202 and the other components of the systems 100 and 200. For instance, the communication unit 308 may include, but is not limited to, CAT-type interfaces; wireless transceivers for sending and receiving signals using Wi-Fi™; Bluetooth®, cellular communications, etc.; USB interfaces; various combinations thereof; etc. In some implementations, the communication unit 308 can link the processor 302 to the network 202, which may in turn be coupled to other processing systems. The communication unit 308 can provide other connections to the network 202 and to other entities of the system 100 using various standard communication protocols, including, for example, those discussed elsewhere herein.

Depending on the configuration, the components of systems 100 and 200, such as but not limited to 102, 104, 222, 162, 164, 166, 168, 114, 116, 118, 120, 122, 130, 132, 134, 136, 138, 140, 142, 144, 146, 148, 150, 152, 154, 156, 158, and/or 160 may be communicatively coupled by the bus 306, the processor 302, and/or network 202 to one another. In some implementations, one or more of the components 102, 104, 222, 162, 164, 166, 168, 114, 116, 118, 120, 122, 130, 132, 134, 136, 138, 140, 142, 144, 146, 148, 150, 152, 154, 156, 158, and/or 160 may be implemented via software, hardware, or a combination of the foregoing. These components may comprise logic and/or software that are executable by the processor 302 to provide various acts and functionality. In some implementations, one or more of the components 102, 104, 222, 162, 164, 166, 168, 114, 116, 118, 120, 122, 130, 132, 134, 136, 138, 140, 142, 144, 146, 148, 150, 152, 154, 156, 158, and/or 160 may be stored in the memory 304 of and accessible and executable by the processor 302. In any of the foregoing implementations, these components 102, 104, 222, 162, 164, 166, 168, 114, 116, 118, 120, 122, 130, 132, 134, 136, 138, 140, 142, 144, 146, 148, 150, 152, 154, 156, 158, and/or 160 may be adapted for cooperation and communication with the processor 302, one another, and other components.

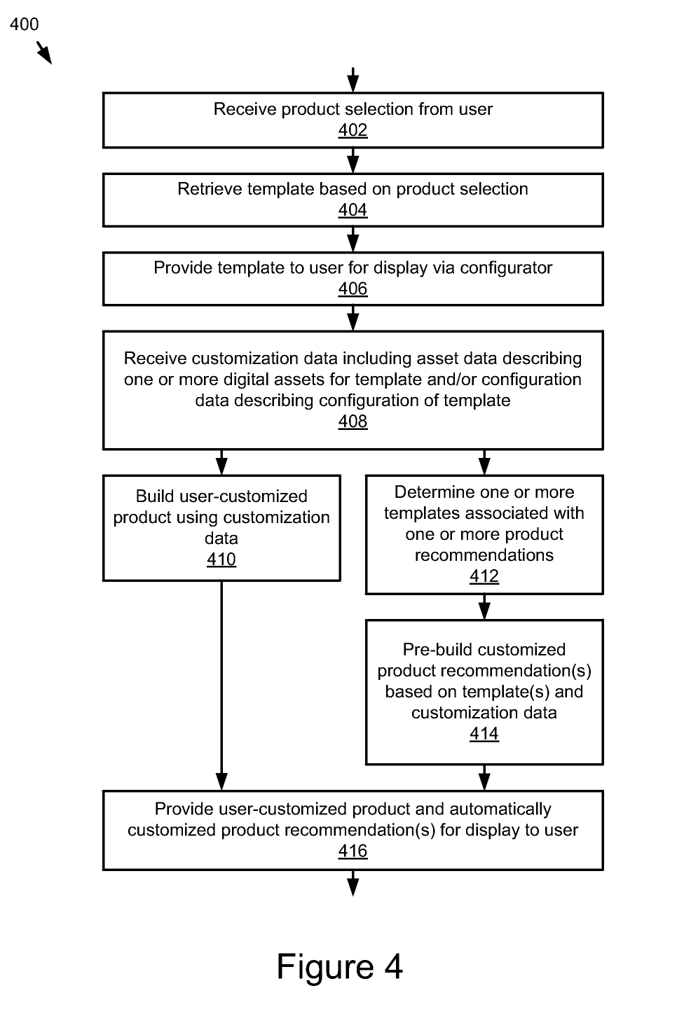

FIG. 4 is a flowchart of an example method 400 for providing user-customized products and automatically pre-customized product recommendations. In block 402, the configuration engine 114 receives a product selection from a user, which selects a customizable product for configuration. In response, the configuration engine 114 may retrieve 404 a template associated with the customizable product based on the product selection and provide 406 the template to the user for display via a configurator (e.g., the configurator 104). For instance, the configurator server 116 may receive a request from the user application 102 that includes a product identifier and may use the product identifier to query the template repository 122 for the associated template. The configurator 104 may include options for configuring the configurable aspects of the template. In some instances, the configurator 104 is a program provided by the configurator server 116 to the user application 102, and executable by the user application 102 to provide various user interface elements for configuring template of the customizable product. An example of a configurator interface is provided in FIG. 13 and discussed in further detail elsewhere herein.

In block 408, the configuration engine 114 receives customization data for customizing the product. The customization data includes one or more of configuration data for configuring a template associated with the product and asset data describing one or more digital assets for the template. In response to receiving the customization data, the product builder 130 may build 410 a user-customized version of the product using the template and the customization data. In some embodiments, the user-customized product builder 134 may build the user-customized version of the product as discussed elsewhere herein. In association with building the user-customized version of the product, the recommender 150 may pre-customize one or more product recommendations to provide in association with the user-customized version of the product. For instance, in block 412 the recommender 150 may determine one or more templates associated with one or more customizable product recommendations and, in block 414, may automatically pre-build one or more customized product recommendations based on the one or more templates and the customization data. In block 416, the product builder 130 or another component of the enterprise system 112 provides the user-customized version of the product and the one or more customized product recommendations that were automatically pre-built for display to the user.

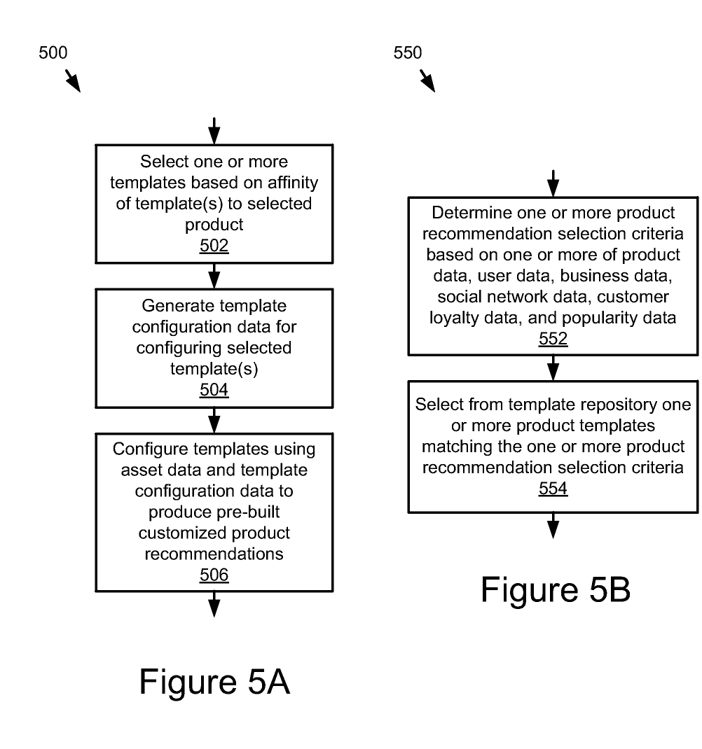

FIG. 5A is a flowchart of an example method 500 for determining templates and automatically pre-building customized product recommendations. In some embodiments, the method 500 is an expansion of the operations described in blocks 412 and 414. In block 502 of the method 500, the selector 152 selects the one or more templates based on an affinity of each of the one or more templates to the product. In block 504, the configuration mapper 154 or the configuration normalizer 158 generates from the configuration data, template configuration data for configuring each of the one or more templates associated with the one or more customizable product recommendations. In block 506, the configuration mapper 154 or the configuration normalizer 158 (depending on the embodiment) configures each of the one or more templates using the asset data and the template configuration data to produce pre-built customized product recommendations.

FIG. 5B is a flowchart of an example method 550 for selecting product templates from the template repository 122. In some embodiments, the method 550 is an expansion of the operations described in block 502 of the method 500. In block 552, the selector 152 determines one or more product recommendation selection criteria based on one or more of a product data, user data, business data, social network data, customer loyalty data, and popularity data, and in block 554 selects from the template repository 122 the one or more templates based on the one or more templates matching the one or more product recommendation selection criteria.

FIG. 6 is a flowchart of an example method 600 for normalizing templates using a canonical model. In block 602, the method 600 determines a canonical model for normalizing data describing a set of templates associated with a catalog of configurable products. In some embodiments, the canonical model may be user-specified, machine-learned, a combination of the foregoing, etc. In some cases, the canonical model may be included in and referenced by the configuration normalizer 158. In block 604, the configuration normalizer 158 may normalize the data associated with each of the templates of the set using the canonical model to produce a canonical representation of each of the templates and may store a set of normalized data for each of the templates of the set in a data store (e.g., the memory 304, a non-transitory long-term storage device, DBMS, NoSQL database, etc.) in block 606.

FIG. 7 is a flowchart of an example method 700 for populating templates using the canonical model. In block 702, the configuration normalizer 158 queries a data store for a canonical representation for each of the one or more templates associated with the one or more customizable product recommendations. In block 704, the configuration normalizer 158 normalizes one or more of the configuration data and the asset data. In block 706, the configuration normalizer 158 populates each template of the one or more templates associated with the one or more customizable product recommendations using a corresponding canonical representation of the template and one or more of the normalized configuration data and the normalized asset data.

FIG. 8 is a flowchart of an example method 800 for generating and storing mapping data. In block 802, the configuration mapper 154 determines which fields of templates relate to one another and, in block 804, the configuration mapper 154 generates and stores mapping data describing related fields in a data store.

FIG. 9 is a flowchart of an example method 900 for populating templates using mapping data. In block 902, the configuration mapper 154 queries a data store for mapping data mapping a (first) template associated with the user-customized version of the product with one or more (second) templates associated with the one or more customizable product recommendations. In block 904, the configuration mapper 154 determines one or more fields in each of the one or more second templates that are related to one or more fields in the first template as related fields based on the mapping data. In block 906, the configuration mapper 154 populates the related fields in the one or more second templates using the customization data and the asset data.

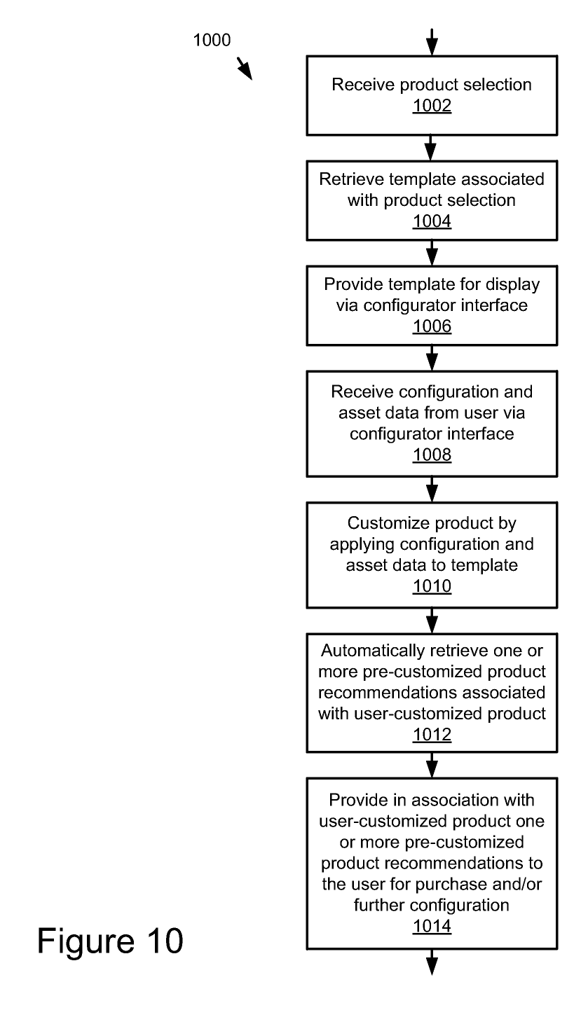

FIG. 10 is a flowchart of an example method 1000 for customizing a product and automatically receiving pre-customized product recommendations. In some embodiments, the method 1000 represents a method that is performed client-side. In block 1002, the user application 102 receives a product selection selecting a product from a user via a computing device and, responsive thereto, the user application 102 retrieves via the computing device a template associated with the product selection in block 1004. In block 1006, the configurator 104 provides the template for display via a configurator interface presented by the computing device and, in block 1008, the configurator 104 receives one or more of configuration data and asset data from the user via the configurator interface. Responsive to receiving this data, the configurator 104 customizes a user-customizable product associated with the template in block 1010 by applying one or more of the configuration data and the asset data to the template and automatically retrieves from a computer network one or more pre-customized product recommendations associated with the user-customizable product in block 1012. The configurator 104 then provides in association with the user-customizable product the one or more pre-customized product recommendations to the user via the computing device for purchase or further configuration in block 1014.

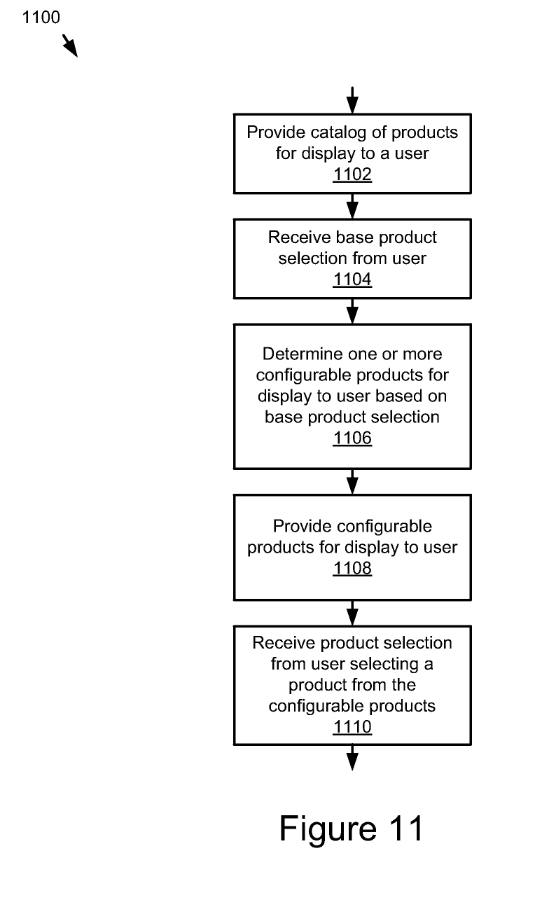

FIG. 11 is a flowchart of an example method 1100 for browsing a product catalog and selecting a product. In block 1102, the catalog engine 162 provides a catalog of configurable products for display to a user and receives a base product selection from a user responsive thereto in block 1104. The base product may reflect a product category, such as appointment cards. Next, the catalog engine 162 determines 1106 one or more configurable products for display to the user based on the base product selection and provides 1108 them for display to the user. For instance, the catalog engine 162 may display different types of user-configurable appointment cards. The catalog engine 162 then receives a product selection from the user selecting a product from the configurable products in block 1110.

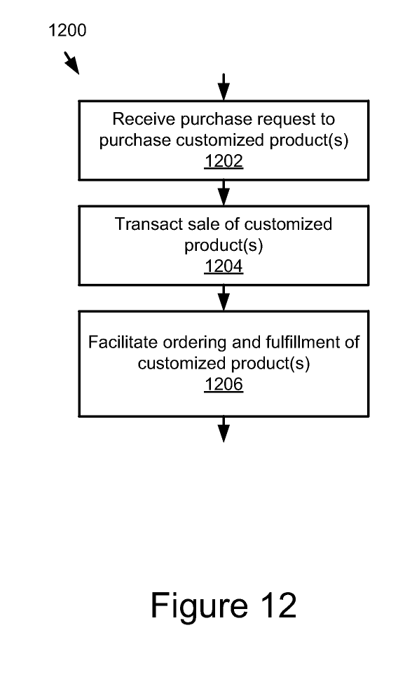

FIG. 12 is a flowchart of an example method 1200 for sale transaction and order fulfillment. In block 1202, the e-commerce engine 138 receives a purchase request to purchase one or more customized products including one or more of a user-customized product and an automatically pre-customized product based on the customization data provided to customize the user-customized product. In block 1204, the e-commerce engine 138 transacts a sale of the customized product and then the e-commerce engine 138 and the fulfillment engine 144 cooperatively facilitate in block 1206 the ordering and fulfillment of the customized product(s).

FIG. 13 is a graphic representation of an example configurator interface 1300 for customizing a product and receiving pre-customized product recommendations. In this embodiment, a business card 1302 is displayed as the product being configured by a user, although any type of product or service suitable for configuration may be configured via a similar interface. As depicted, the configurator interface 1300 includes a representation of the business card 1302 that is iteratively updated as the user configures the different aspects of the business card 1302. In the depicted view, the user is configuring the amount of business cards to order and has already input his name and his contact information (e.g., business address, phone number, fax number, email address, etc.). Responsive to inputting that information, the configurator 104 provided that information as customization data to the configuration engine 114, which in turn provided the customization data to the product builder 130 which both built the representation of the business card 1302 depicted in the configuration interface 1300 and automatically pre built a set of customized product recommendations including the appointment card 1308 and the button 1310. The user may select either of the automatically pre-customized products 1308 and 1310, which would open that customized product in the configurator 104 and allow the user to further configure it to his/her liking. The user may also add the pre-customized products to cart, save them for later configuration, and/or share the products with other users (e.g., via an electronic message, social network, etc.). It should be understood that numerous other views and configuration-related interfaces are also contemplated, such as a designer interface allowing the user to enter and format information to include in the product being customized from multiple perspectives (e.g., a front side, back side, etc.), options for selecting different grades of the product (e.g., paper stock), etc.

While various embodiments herein are described within the context of copy and print products, it should be understood that these embodiments are applicable to other numerous other types of products and services, as noted elsewhere herein. In addition, in the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, AMQP, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A method comprising:
receiving, using one or more computing devices, customization data customizing a product, the customization data including one or more of configuration data for configuring a template associated with the product and asset data describing one or more digital assets for the template;
building, using the one or more computing devices, a user-customized version of the product using the template and the customization data;
in association with building the user-customized version of the product, determining, using the one or more computing devices, one or more templates associated with one or more customizable product recommendations;
automatically pre-building, using the one or more computing devices, one or more customized product recommendations based on the one or more templates and the customization data; and
providing, using the one or more computing devices, the user-customized version of the product and the one or more customized product recommendations that were automatically pre-built for display to the user.

2. The method of claim 1, further comprising:
generating, from the configuration data using the one or more computing devices, template configuration data for configuring each of the one or more templates associated with the one or more customizable product recommendations, wherein automatically pre-building the one or more customized product recommendations includes configuring each of the one or more templates using the asset data and the template configuration data.

3. The method of claim 1, wherein determining the one or more templates associated with the one or more customizable product recommendations includes:
selecting the one or more templates based on an affinity of each of the one or more templates to the product.

4. The method of claim 3, wherein selecting the one or more templates based on the affinity of each of the one or more templates to the product includes:
determining one or more product recommendation selection criteria based on one or more of a product data, user data, business data, social network data, customer loyalty data, and popularity data; and
selecting, from a template repository the one or more templates based on the one or more templates matching the one or more product recommendation selection criteria.

5. The method of claim 1, wherein automatically pre-building the one or more customized product recommendations based on the one or more templates and the customization data includes:
using a canonical model or mapping data to populate the one or more templates associated with the one or more customizable product recommendations.

6. The method of claim 5, wherein using the canonical model to populate the one or more templates associated with the one or more customizable product recommendations includes:
querying a data store for a canonical representation for each of the one or more templates associated with the one or more customizable product recommendations;
normalizing one or more of the configuration data and the asset data; and
populating each template of the one or more templates associated with the one or more customizable product recommendations using a corresponding canonical representation of the template and one or more of the normalized configuration data and the normalized asset data.

7. The method of claim 5, wherein using the mapping data to populate the one or more templates associated with the one or more customizable product recommendations includes:
querying a data store for mapping data mapping the template associated with the user-customized version of the product with the one or more templates associated with the one or more customizable product recommendations;
determining one or more fields in each of the one or more templates that are related to one or more fields in the template as related fields based on the mapping data; and
populating the related fields in the one or more templates using the customization data.

8. The method of claim 1, further comprising:
receiving, using the one or more computing devices, a product selection from the user, the product selection selecting the product;
retrieving, using the one or more computing devices, the template based on the product selection; and
providing, using the one or more computing devices, the template to the user for display via a configurator.

9. The method of claim 1, further comprising:
receiving, using the one or more computing devices, a purchase request to purchase the user-customized version of the product and at least one of the one or more customized product recommendations;
transacting, using the one or more computing devices, a sale of the user-customized version of the product and the at least one of the one or more customized product recommendations; and
facilitating, using the one or more computing devices, ordering and fulfillment of the user-customized version of the product and the at least one of the one or more customized product recommendations.

10. A computer-implemented method comprising:
determining, using one or more computing devices, a canonical model for normalizing data describing a set of templates associated with a catalog of configurable products;
normalizing, using the one or more computing devices, the data associated with each of the templates of the set using the canonical model to produce a canonical representation of each of the templates; and
storing, using the one or more computing devices, a set of normalized data for each of the templates of the set in a data store.

11. The method of claim 10, further comprising:
receiving, using the one or more computing devices, a request to automatically pre-build one or more customized product recommendations in association with a user-customized version of a product;
determining, using the one or more computing devices, one or more templates associated with one or more customizable product recommendations;
querying, using the one or more computing devices, a data store for the canonical representation of each of the one or more templates;
normalizing, using the one or more computing devices, one or more of configuration data and asset data associated with the user-customized version of the product;
populating, using the one or more computing devices, the canonical representation of each of the one or more templates using one or more of the normalized configuration data and the normalized asset data; and
generating, using the one or more computing devices, one or more customized product recommendations respectively from a populated version of the canonical representation of each of the one or more templates.

12. The method of claim 10, further comprising:
receiving, using the one or more computing devices, template data from one or more third-party sources via a computer network, the template data describing one or more templates associated with one or more configurable products producible by the one or more third-party sources;
including, using the one or more computing devices, the one or more configurable products producible by the one or more third-party sources in the catalog; and
storing, using the one or more computing devices, the one or more templates in a template repository in association with the set of templates.

13. A computer-implemented method, comprising:
determining, using one or more computing devices, mapping data for a set of templates associated with a catalog of configurable products, the mapping data describing fields of the templates that are related; and
storing, using the one or more computing devices, the mapping data in a data store.

14. The method of claim 13, further comprising:
receiving, using the one or more computing devices, a request to automatically pre-build one or more customized product recommendations in association with a user-customized version of a product;
determining, using the one or more computing devices, one or more templates associated with one or more customizable product recommendations;
querying, using the one or more computing devices, the data store for a set of mapping data mapping a first template associated with the product with one or more second templates associated with the one or more customizable product recommendations;
determining, using the one or more computing devices, one or more fields in the one or more second templates that are related to one or more fields in the first template based on the mapping data; and
populating, using the one or more computing devices, the one or more fields in the one or more second templates that are related to the one or more fields in the first template using customization data associated with the user-customized version of the product.

15. The method of claim 13, further comprising:
receiving, using the one or more computing devices, template data from one or more third-party sources via a computer network, the template data describing one or more templates associated with one or more configurable products producible by the one or more third-party sources;
including, using the one or more computing devices, the one or more configurable products producible by the one or more third-party sources in the catalog; and
storing, using the one or more computing devices, the one or more templates in a template repository in association with the set of templates.

16. A computer-implemented method, comprising:
receiving a product selection selecting a product from a user via a computing device;
retrieving via the computing device a template associated with the product selection;
providing the template for display via a configurator interface presented by the computing device;
receiving one or more of configuration data and asset data from the user via the configurator interface;
customizing a user-customizable product associated with the template by applying one or more of the configuration data and the asset data to the template;
automatically retrieving from a computer network one or more pre-customized product recommendations associated with the user-customizable product; and
providing in association with the user-customizable product the one or more pre-customized product recommendations to the user via the computing device for purchase or further configuration.

17. The method of claim 16, wherein applying the one or more of the configuration data and the asset data to the template includes:
sending a request to a configuration engine accessible via the computer network, the request requesting the configuration engine to customize the user-customizable product using the one or more of the configuration data and the asset data;
receiving data describing a customized version of the user-customizable product; and
updating the configurator interface to present the customized version of the user-customizable product based on the data.

18. A system comprising:
one or more computing devices;
a configuration engine executable by the one or more computing devices to retrieve a template based on a product selection selecting a product and to provide the template to a user for display via a configurator, the configuration engine further executable by the one or more computing devices to receive customization data including one or more of configuration data for configuring a template associated with the product and asset data describing one or more digital assets for the template; and
a product builder executable by the one or more computing devices to build a user-customized version of the product using the template and the customization data and to automatically pre-build one or more customized product recommendations in association with the user-customized version of the product based on the customization data and one or more templates associated with one or more customizable product recommendations, the product builder coupled to the configuration engine to receive the template, the one or more templates, and the customization data.

19. The system of claim 18, wherein the configuration engine includes a configuration server executable by the one or more computing devices to receive the customization data from a client device of the user, and to provide the user-customized version of the product and the one or more customized product recommendations automatically pre-built by the product builder for display to the user.

20. The system of claim 18, further comprising:
a recommender executable by the one or more computing devices to determine one or more customized product recommendations.

21. The system of claim 20, wherein to determine the one or more customized product recommendations includes populating the one or more templates associated with the one or more customizable product recommendations, the recommender being coupled to the product builder to receive the customization data.

22. The system of claim 21, wherein to determine the one or more templates associated with the one or more customizable product recommendations includes selecting the one or more templates based on an affinity of each of the one or more templates to the product.

23. The system of claim 22, wherein to select the one or more templates based on the affinity of each of the one or more templates to the product includes:
determining one or more product recommendation selection criteria based on one or more of a product data, user data, business data, social network data, customer loyalty data, and popularity data; and
selecting from a template repository the one or more templates based on the one or more templates matching the one or more product recommendation selection criteria.

24. The system of claim 21, wherein the recommender is further executable by the one or more computing devices to generate template configuration data from the configuration data, the template configuration data being usable by the recommender to populate each of the one or more templates associated with the one or more customizable product recommendations.

25. The system of claim 21, wherein the recommender is further executable by the one or more computing devices to use a canonical model or mapping data to populate the one or more templates associated with the one or more customizable product recommendations.

26. The system of claim 25, wherein to use the canonical model to populate the one or more templates associated with the one or more customizable product recommendations includes:
querying a data store for a canonical representation for each of the one or more templates;
normalizing one or more of the configuration data and the asset data; and
populating each template of the one or more templates using a corresponding canonical representation of the template and one or more of the normalized configuration data and the normalized asset data.

27. The system of claim 25, wherein to use the mapping data to populate the one or more templates associated with the one or more customizable product recommendations includes:
querying a data store for mapping data mapping the template associated with the product with the one or more templates associated with the one or more customizable product recommendations;
determining one or more fields in each of the one or more templates that are related to one or more fields in the template as related fields based on the mapping data; and
populating the related fields in the one or more templates using the customization data.
